(19) United States
(12) Patent Application Publication
(10) Pub. No.: US 2009/0026348 A1
(43) Pub. Date: Jan. 29, 2009

(54) Object Caddy

(76) Inventor: Anita Paulette Sopel, Rancho Santa Margarita, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/170,389

(22) Filed: Jul. 9, 2008

Related U.S. Application Data
(60) Provisional application No. 60/961,695, filed on Jul. 24, 2007.

(51) Int. Cl. A47G 29/00

(52) U.S. Cl. 248/686

(57) ABSTRACT

A method and apparatus for the hands-free holding and carrying of objects.

### CROSS-REFERENCE TO RELATED APPLICATIONS

This application claims the benefit of U.S. provisional application No. 60/961,695, entitled “Letsfetch: A Pet Device to Carry a Tennis Ball Attached to a Dogs Caller,” filed on Jul. 24, 2007.

### FIELD OF THE INVENTION

This invention relates generally to an apparatus and method for holding and carrying objects. More specifically, the invention relates to an apparatus and method for the hands-free holding and carrying of an object.

### BRIEF DESCRIPTION OF THE DRAWINGS

A better understanding of at least certain embodiments of the invention can be obtained from the following detailed description in conjunction with the following drawings, in which:

FIG. 1 illustrates an exemplary object caddy according to one embodiment of the invention.

FIG. 2 illustrates multiple angles of an exemplary object caddy according to one embodiment of the invention.

FIG. 3 illustrates an exemplary method for utilizing an object caddy according to one embodiment of the invention.

### DETAILED DESCRIPTION

Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of embodiments of the present invention.

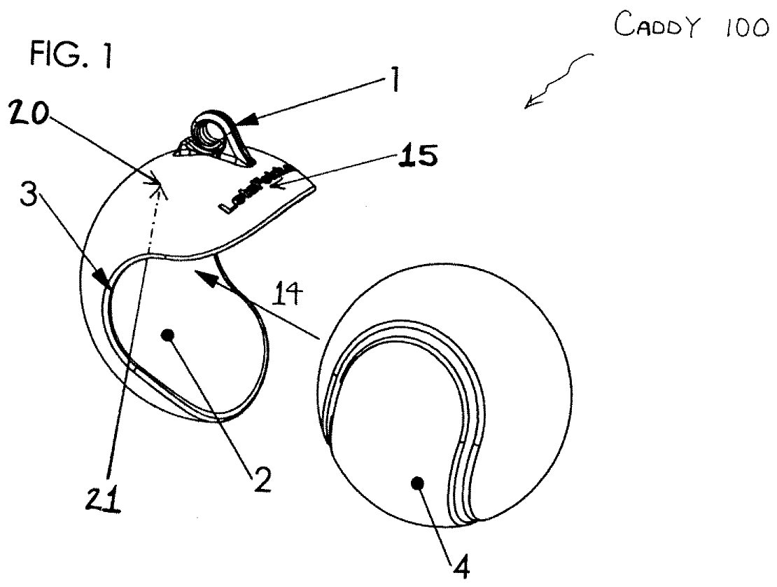

A method and apparatus for hands-free holding and carrying of an object is described. FIG. 1 illustrates an exemplary object caddy according to one embodiment of the invention. In the illustrated embodiment, exemplary caddy 100 consists of a spherical shaped apparatus with an opening 2 to hold objects, such as, for example, ball 4 shown in FIG. 1. However, this is given by way of example and not of limitation, as caddy 100 may be configured in any shape depending on its intended use. For example, the caddy 100 may be configured in the shape of a football if it is intended to be utilized as a football caddy. Likewise, caddy 100 can be configured in any shape such as, for example, an oval, a cylinder, a square, a rectangle, or any other shape, and can be of any size to hold any size object such as a tennis ball, golf ball, football, marble, or any other intended object. Caddy 100 is not limited to holding balls, but instead, may be used to carry any object or device.

Caddy 100 includes an outside surface 20 and an inside surface 21. In at least certain embodiments, outside surface 20 is convex and inside surface 21 is concave. As discussed above, surfaces 20 and 21 are shaped according to the intended use of the caddy. Additionally, surfaces 20 and 21 of caddy 100 may be manufactured using any material such as, for example, plastic, rubber, metal, composite material, wood, glass, carbon, or any other material or combination of materials. In the case of softer, more pliable materials, the caddy opening 2 can be made smaller than the object it is intended to hold, and allowed to flex naturally according to the properties of the material as the object is placed into the caddy. In the case of harder, less pliable materials, the opening 2 of the caddy can be made larger to accommodate placing the object into the apparatus. In fact, caddy 100 can be made of very hard and inflexible materials, and can be designed with points of various flex, such as pivot points or the like, to facilitate placing the intended object into the caddy 100. Further, caddy 100 may be manufactured using plastic injection molding in at least certain embodiments. However, the invention is not so limited, as caddy 100 may be manufactured using any known manufacturing processes or methods.

As indicated above, Caddy 100 includes an opening 2. Opening 2 is configured so as to accept the intended objects to be placed into the caddy 100. As discussed above, the size of the opening 2 depends on the material used to manufacture the caddy 100 as well as the intended object to be placed within the caddy 100. In the illustrated embodiment, caddy 100 is configured to hold a ball 4. The opening 2 of caddy 100 is configured in such a way so as to allow both the intended object to be easily placed within the caddy 100 while at the same time allowing the object to be held securely within the caddy, and to resist from falling out under the force of gravity or other forces. In FIG. 1, opening 2 is shown to include an outer lip 3. Outer lip 3 is shaped to facilitate ease of placement and secure holding within the caddy 100. In at least certain embodiments, outer lip 3 is shaped in the shape of the letter “C” as depicted in FIG. 1 so as to provide the necessary placement and holding requirements. However, the invention is not so limited as outer lip 3 may be configured in any shape so as to allow both the intended object to be easily placed within the caddy 100 while at the same time allowing the object to be held securely within the caddy to resist from falling out under the force of gravity or other forces.

Further, caddy 100 includes a logo 15 located on surface 20. However, this is given by way of example and not of limitation as caddy 100 may include any picture, drawings, or other artwork on surface 20. The scope of the invention is intended to cover any such artwork and/or drawings on surface 20, such as, for example, a happy face, a sad face, a picture of a dog, cat, horse, the empire state building, etc. Any such artwork, whether drawn on the surface or raised into the surface during the manufacturing process, is envisioned to be within the scope of this invention.

Finally, caddy 100 includes an attachment device 1 coupled thereto. Attachment device 1 may be any mechanism used for attaching the caddy 100 to other objects such as a dog collar, belt loop, backpack, bicycle, automobile, tent post, or any other object. In the illustrated embodiment, attachment device 1 is a clip that can be attached to an object. Attachment device 1 can be attached to objects using a separate ring, carabineer, clip or other device (not shown), or can be attached to objects without the use of a separate device. Moreover, attachment device 1 can be configured to be permanently affixed to the caddy 100 or can be configured to be removable. For example, attachment device 1 can be permanently affixed to caddy 100 via the molding and manufacturing process, or by use of strong contact cement or glue. However, the invention is not so limited as any method of attaching attachment device 1 to caddy 100 is envisioned to be within the scope of the invention. Likewise, attachment device 1 may be configured to be removable from caddy 100, such as in the case where it is desired to use caddy 100 with different size and/or types of rings, clips, carabineers, and etc.

For example, in the illustrated embodiment, attachment device 1 is configured in a pig-tail shape to maintain attachment to a backpack, dog collar, belt loop, or other object under the force of gravity. In the illustrated embodiment, attachment device 1 is configured in the pig-tail configuration so as to have the added feature of a pull-away/breakaway device for safety. In this embodiment, the caddy 100 will remain attached to its intended object such as a belt loop, dog collar or backpack under normal activity. However, under more extreme activity, the pig-tail embodiment of attachment 1 will allow the caddy 100 to be pulled away freely for safety or other reasons. Other types and shapes of attachment devices are envisioned to be within the scope of the present invention. Additionally, attachment device 1 may be breakaway or non-breakaway attachment depending on the intended use of the caddy 100. In the breakaway configuration, at least in certain embodiments, attachment device 1 is a relatively pliable material curled up under itself to create the breakaway functionality. Other such breakaway mechanisms are envisioned such as, for example, a circle with a slice cut through.

Similarly, several sizes may be used for attachment device 1 and may be swapped out if the attachment device 1 is removable. This works for the case where there is at least one alternative intended use for caddy 100. For example, caddy 100 may have a small attachment device 1 for attachment to a dog collar and a correspondingly larger attachment device 1 for attaching to a larger object such as a tent post, for example.

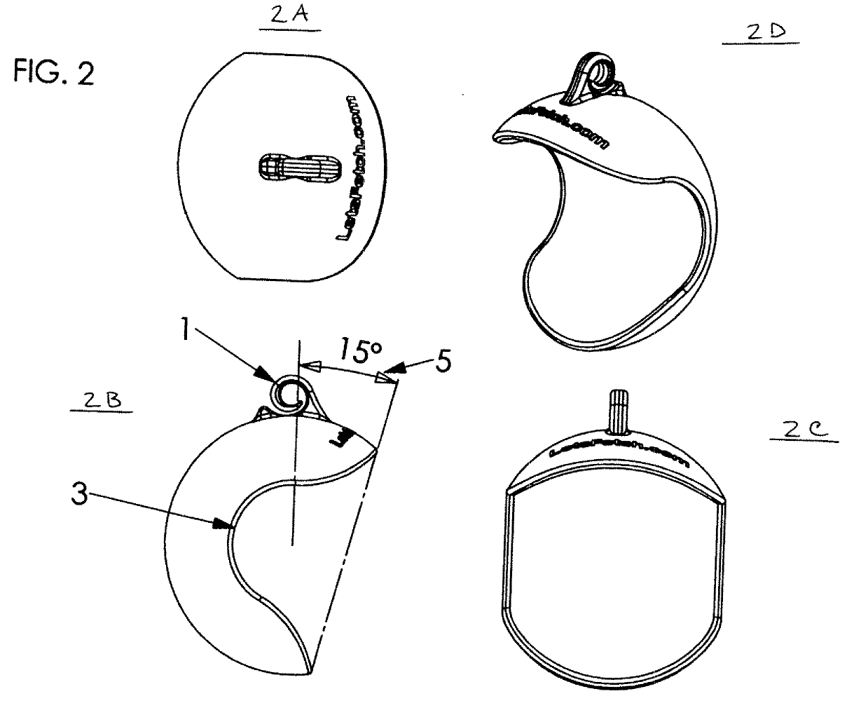

Referring to FIG. 2, which illustrates multiple angles of an exemplary caddy according to one embodiment of the invention. FIG. 2 includes top view 2A, side view 2B, front view 2C and angled side view 2D. As discussed above, in at least certain embodiments, caddy 100 includes attachment device 10, logo 15 and opening 2 as can be seen from the various angles provided in FIG. 2.

According to the illustrated embodiment, attachment device 1 may be affixed (permanently or removable) to the surface 20 of caddy 100 so as to hold the intended object securely while at the same time allowing for easy insertion and removal of the intended object, such as ball 4 of FIG. 1. In at least certain embodiments, the center point of the attachment device 1 is located at an angle 5 from the opening 2 of the caddy 100. In the illustrated embodiment, angle 5 is configured to be around fifteen degrees (15°) allowing the caddy 100 to hang in the upright position. However, this is given by way of example and not limitation as any angle 5 can be chosen. In the case where angle 5 is chosen to be so large that the caddy hangs upside down, the opening 13 must be adjusted accordingly so as to maintain the intended object securely inside caddy 100.

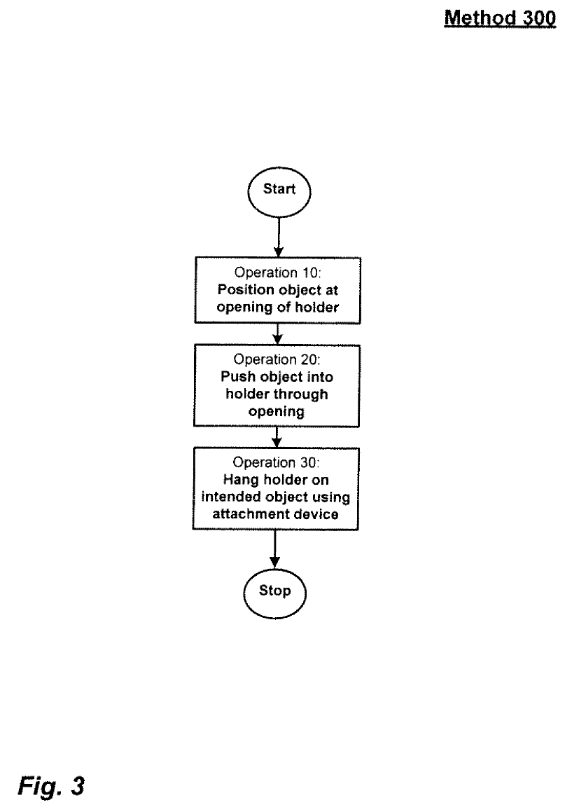

Referring now to FIG. 3, which illustrates an exemplary method for utilizing a caddy according to one embodiment of the invention. Method 300 begins at operation 10 where the intended object, such as a ball 4 of FIG. 1, is positioned at the opening 2 of the caddy 100. At operation 20, the object is pushed into the caddy 100 through the opening 2 as illustrated by arrow 14 in FIG. 1. Once the object is securely placed inside caddy 100, control flows to operation 30 where the caddy 100 is attached to an intended object, such as a dog collar or tent post, by hanging the caddy 100 by its attachment device 1 onto the object. This completes method 300.

The exemplary advantages of the apparatus and method herein described are that, in at least certain embodiments, an intended object is placed into the caddy to provide hands-free holding and carrying of the object. This is particularly useful if used for a pet such as a dog, where the pet can have the object caddy attached to its collar, and can be allowed to carry around its own ball for later use, for example, in a game of “fetch.”

Throughout the foregoing specification, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. When a particular feature, structure, or characteristic is described in connection with an embodiment, it is submitted that it is within the knowledge of one skilled in the art to bring about such a feature, structure, or characteristic in connection with other embodiments whether or not explicitly described. Various changes may be made in the structure and embodiments shown herein without departing from the principles of the invention. Further, features of the embodiments shown in various figures may be employed in combination with embodiments shown in other figures.

In the description as set forth above and claims, the terms “coupled” and “connected,” along with their derivatives, may be used. It should be understood that these terms are not intended to be synonymous with each other. Rather, in particular embodiments, “connected” is used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Embodiments of the invention may include various operations as set forth above or fewer operations or more operations or operations in an order which is different from the order described herein.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow as well as the legal equivalents thereof.

What is claimed is:

1. An apparatus comprising:
an object caddy including an outside surface and an inside surface, the object caddy including:
an opening in which to place a first object, the opening configured to allow the first object to be both easily positioned and held securely within the object caddy to resist falling out; and
an attachment device coupled with the object caddy to attach the object caddy to other objects.

2. The apparatus of claim 1, wherein the attachment device is configured as a breakaway device for safety.

3. The apparatus of claim 2, wherein the attachment device is configured in a pig-tail shape.

4. The apparatus of claim 3, wherein the first object is a ball.

5. The apparatus of claim 4, wherein the other objects includes a dog collar.

6. The apparatus of claim 3, wherein the opening includes an outer lip.

7. The apparatus of claim 6, wherein the outer lip is configured in a “C” shape.

8. A method comprising:
positioning a first object at an opening of an object caddy, wherein the opening is configured to allow a first object to be both easily positioned and held securely within the object caddy to resist falling out;
pushing the first object into the object caddy through the opening; and
hanging the caddy on other objects using an attachment device coupled with the object caddy, the attachment device to attach the caddy the other objects.

9. The apparatus of claim 8, wherein the attachment device is configured as a breakaway device for safety.

10. The apparatus of claim 9, wherein the attachment device assumes a pig-tail configuration.

11. The apparatus of claim 10, wherein the first object is a ball.

12. The apparatus of claim 11, wherein the other objects includes a dog collar.

13. The apparatus of claim 10, wherein the opening includes an outer lip.

14. The apparatus of claim 13, wherein the outer lip is configured in a “C” shape.
